(19) United States
(12) Patent Application Publication
(10) Pub. No.: US 2025/0304497 A1
(43) Pub. Date: Oct. 2, 2025

(54) LIGNIN-BASED SUPERPLASTICIZERS AND WATER REDUCER FOR RHEOLOGICAL MODIFICATION OF CEMENTITIOUS MATERIALS

(71) Applicant: Alliance for Sustainable Energy, LLC, Golden, CO (US)

(72) Inventors: Kyle Edward O’Neil FOSTER, Westminster, CO (US); Adewale ODUKOMAIYA, Denver, CO (US); Paul William MEYER, Lakewood, CO (US); Nestor Fabian RODRIGUEZ BUITRAGO, Lakewood, CO (US); Xiaowen CHEN, Littleton, CO (US); Michael E. HIMMEL, Littleton, CO (US); Michael Brandon GRIFFIN, Denver, CO (US); Anastasia Nicole ADAY, Boulder, CO (US)

(21) Appl. No.: 19/092,067

(22) Filed: Mar. 27, 2025

Related U.S. Application Data
(60) Provisional application No. 63/571,006, filed on Mar. 28, 2024.
(60) Provisional application No. 63/572,440, filed on Apr. 1, 2024.

(51) Int. Cl. C04B 24/18; B28B 3/20; C04B 14/06; C04B 103/30; C04B 111/00; C08H 7/00

(52) U.S. Cl. CPC C04B 24/18; B28B 3/20; C04B 14/06; C08H 6/00; C04B 2103/302; C04B 2111/00129

(57) ABSTRACT

Admixtures for concrete as well as methods including precision control of fabrication of concrete are described. Chemical admixtures for water reduction, including a more reactive lignin byproduct that is suitable for chemical modifications to mimic the properties of polycarboxylate ether (PCEs) admixtures are described. This includes the use of lignin-based water-reducing admixture in cement pastes and mortar mixtures for 3D-printing (i.e., additive manufacturing) to produce 3D-printed samples with appropriate extrudability and buildability.

### CROSS-REFERENCE TO RELATED APPLICATIONS

This application claims priority to U.S. Provisional Patent Application Nos. 63/571,006 filed on Mar. 28, 2024, and 63/572,440 filed on Apr. 1, 2024, the contents of which are incorporated herein by reference in their entirety.

### CONTRACTUAL ORIGIN

This invention was made with government support under Contract No. DE-AC36-08GO28308 awarded by the Department of Energy. The government has certain rights in this invention.

### BACKGROUND

Concrete is the most used construction material in the world, and accounts for approximately 8% of annual anthropogenic carbon dioxide emissions. Specialized applications of concrete for construction such as high-strength and additively manufactured (i.e., 3D printed) concrete require significantly lower amounts of water, drastically reducing flowability. Thus, the use of chemical admixtures such as superplasticizers (SPs) has become vital to customize the flow characteristics (i.e., workability) by increasing plasticity of these concretes. Using SPs enables is the use of lower water contents (i.e., lower water to cement ratio) which leads to stronger, more durable concrete. However, most traditional SPs are polycarboxylate ethers (PCEs), which can be expensive to produce and contribute significantly to the carbon emissions for the concrete manufacturing process. Thus, there remains a need for a more cost-effective SP or SP alternative.

### SUMMARY

An aspect of the present disclosure is a method including preparing a lignin-based water-reducing admixture (LigWRA), combining the LigWRA with a binder and a liquid to form a cement, and extruding the cement to form a concrete. In some embodiments, the binder includes at least one of sand or gravel. In some embodiments, the binder and LigWRA are combined in a ratio of approximately 0.75. In some embodiments, the liquid is water. In some embodiments, the liquid and the LigWRA are combined in a ratio of approximately 0.35. In some embodiments, the extruding includes: directing the cement through a nozzle to form a shape, and allowing the shape to set to form the concrete. In some embodiments, the allowing is performed for approximately less than twenty four (24) hours. In some embodiments, the cement is in the range of approximately 0.2 wt. % to approximately 0.8 wt. % LigWRA. In some embodiments, the preparing includes isolating a lignin in a black liquor, oxidizing the lignin, dialyzing the lignin, and lyophilizing the lignin, resulting in a lignin-based water-reducing admixture (LigWRA). In some embodiments, the isolating includes utilizing a sulfuric acid to precipitate the lignin within the black liquor, centrifuging the lignin, water washing the lignin, and drying the lignin. In some embodiments, the oxidizing includes mixing the lignin with a source of O₂. In some embodiments, the source of O₂ comprises at least one of hydrogen peroxide or ozone. In some embodiments, the dialyzing was performed in the range of approximately 0.5 kDa to approximately 1 kDA for at least eight (8) hours. In some embodiments, the dialyzing results in a particle being removed from the lignin. In some embodiments, the method also includes dissolving the LigWRA in water.

An aspect of the present disclosure is a composition including a lignin-based water-reducing admixture (LigWRA), a binder, and a liquid, wherein the LigWRA includes an isolated lignin from a black liquor byproduct of sustainable aviation fuel. In some embodiments, the composition is in the range of approximately 0.2 wt. % to approximately 0.8 wt. % LigWRA. In some embodiments, the binder includes at least one of sand or gravel. In some embodiments, the liquid includes water. In some embodiments, the composition has a rate of heat generation of approximately 4.0 mW/g.

### BRIEF DESCRIPTION OF THE DRAWINGS

Some embodiments of the present disclosure are illustrated in the referenced figures of the drawings. It is intended that the embodiments and figures disclosed herein are to be considered illustrative rather than limiting.

FIG. 1A illustrates a photograph of a 3D-printing system for small-scale additive manufacturing using the lignin-based water-reducing admixture (LigWRA) of the present disclosure and FIG. 1B illustrates cylindrical elements of LigWRA showing extrudability and buildability of the LigWRA, according to some aspects of the present disclosure.

FIG. 2 illustrates the printability performance of double wall cylinders (made with either LigWRA or a commercial high range water reducing admixture (ComWRA)) to demonstrate the extrudability of the mixtures using a single syringe system, according to some aspects of the present disclosure. Panel a) shows the admixture dosage and number of layers printed, while panel b) shows photographs of the additively manufactured cylinders.

FIG. 3 illustrates the printability performance of single-wall cylinders (made with either LigWRA or ComWRA) showing the stability of thin-wall elements as a function of increasing WRA dosages in the mixtures, according to some aspects of the present disclosure. Panel a) shows the admixture dosage and number of layers printed, while panel b) shows photographs of the additively manufactured cylinders.

FIG. 4 illustrates flow curves of mixtures with panel a) commercial admixture (ComWRA), panel b) lignin-based admixture (LigWRA), panel c) yield stress of LigWRA to ComWRA at pastes of different dosages, and d) the impact LigWRA and ComWRA have on plastic viscosity at different dosages, according to some aspects of the present disclosure.

FIG. 5 illustrates the effect of LigWRA and ComWRA admixtures on panel a) hydration of cement pastes, panel b) heat generation (approximately 100 hours), panel c) magnitude of main peak hydration, and panel d) total heat of (after approximately 100 hours), and panel e) indicator of setting time, according to some aspects of the present disclosure.

### DETAILED DESCRIPTION

The embodiments described herein should not necessarily be construed as limited to addressing any of the particular problems or deficiencies discussed herein. References in the specification to “one embodiment”, “an embodiment”, “an example embodiment”, “some embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

As used herein the term “substantially” is used to indicate that exact values are not necessarily attainable. By way of example, one of ordinary skill in the art will understand that in some chemical reactions 100% conversion of a reactant is possible, yet unlikely. Most of a reactant may be converted to a product and conversion of the reactant may asymptotically approach 100% conversion. So, although from a practical perspective 100% of the reactant is converted, from a technical perspective, a small and sometimes difficult to define amount remains. For this example of a chemical reactant, that amount may be relatively easily defined by the detection limits of the instrument used to test for it. However, in many cases, this amount may not be easily defined, hence the use of the term “substantially”. In some embodiments of the present invention, the term “substantially” is defined as approaching a specific numeric value or target to within 20%, 15%, 10%, 5%, or within 1% of the value or target. In further embodiments of the present invention, the term “substantially” is defined as approaching a specific numeric value or target to within 1%, 0.9%, 0.8%, 0.7%, 0.6%, 0.5%, 0.4%, 0.3%, 0.2%, or 0.1% of the value or target.

As used herein, the term “about” is used to indicate that exact values are not necessarily attainable. Therefore, the term “about” is used to indicate this uncertainty limit. In some embodiments of the present invention, the term “about” is used to indicate an uncertainty limit of less than or equal to ±20%, ±15%, ±10%, ±5%, or ±1% of a specific numeric value or target. In some embodiments of the present invention, the term “about” is used to indicate an uncertainty limit of less than or equal to ±1%, ±0.9%, ±0.8%, ±0.7%, ±0.6%, ±0.5%, ±0.4%, ±0.3%, ±0.2%, or ±0.1% of a specific numeric value or target.

Among other things, the present disclosure relates to admixtures for concrete as well as methods for precision control of fabrication of concrete uses admixtures. Chemical admixtures for water reduction including a more reactive lignin byproduct that is suitable for chemical modifications to mimic the properties of polycarboxylate ether (PCEs) admixtures are described herein. Some embodiments include the use of lignin-based water-reducing admixture in cement pastes and mortar mixtures for 3D-printing (i.e., additive manufacturing). Some embodiments include the use of different dosages of a lignin-based admixture to produce 3D-printed samples with appropriate extrudability and buildability. The rheological characterization shows the flow curve of various mixtures. Finally, the heat of hydration of cement pastes was monitored via isothermal calorimetry to assess the impact of lignin-based admixtures on the hydration process of cement. The present disclosure indicates that the use of biomass by-products, such as lignin-based admixtures have great potential to effectively control the fresh-state properties of cement-based materials.

In this present disclosure, a lignin-based water-reducing admixture (LigWRA) derived from a biorefinery lignin byproduct derived from sustainable aviation fuel production and/or the kraft process is presented. The biorefinery lignin byproduct was subjected to rapid oxidation using an alkaline hydrogen peroxide process to enhance carboxylate content and improve its suitability for use as a cement additive. The performance of this LigWRA admixture within a cementitious system was systematically investigated, assessing its impact on 3D printability, rheological properties, and heat of hydration with respect to a commercial high range water reducing admixture (ComWRA). This present disclosure provides the potential of utilizing lignin-derived additives for enhancing the fresh-state properties and sustainability of cement-based materials.

The effect of ComWRA and LigWRA on cement-based mixtures was assessed via printability tests, rheological characterization, and isothermal calorimetry tests. The materials used in the tests in this present disclosure include Type IL ordinary Portland cement (OPC) compliant with ASTM C595, sand with a maximum particle size of approximately 0.6 mm, a viscosity modifying admixture (VMA), and water in addition to the LigWRA and ComWRA.

In some embodiments, to prepare the LigWRA, the black liquor may be combined with an acid to precipitate the lignin out of the mixture. Exemplary acids may include strong acids such as sulfuric acid, hydrochloric acid, nitric acid, hydrobromic acid, hydroiodic acid, perchloric acid, and/or chloric acid. Then the precipitated lignin can be oxidized with a source of O₂, for example hydrogen peroxide (H₂O₂) and/or ozone (O₂). After the oxidation the mixture may be dialyzed to remove small particles. The resulting composition may be a lignin superplasticizer (referred to herein as LigWRA). As used herein, “black liquor” may refer to a by-product from the kraft process when digesting pulpwood into paper pulp removing lignin, hemicelluloses and other extractives from the wood to free the cellulose fibers.

LigWRA was prepared from corn stover black liquor (a byproduct from the kraft process). The method to prepare the LigWRA first includes isolating the lignin from black liquor through sulfuric acid precipitation, followed by repeatedly centrifuging and water washing, all prior to drying via lyophilization. Lignin can then be oxidized using (i.e., combining with or mixing with) hydrogen peroxide (H₂O₂) in alkaline conditions (pH in the range of about 13 to about 14), at approximately 80° C. for approximately 1 hour using molar ratios of approximately 0.77 for NaOH/H₂O₂ and approximately 2.85 for H₂O₂/lignin. The reaction mixture was then dialyzed (in the range of approximately 0.5 kDa to approximately 1 kDa) overnight and lyophilized forming the proposed LigWRA powder that was then dissolved in water at a weight ratio of about 30%. Other methods or processes for isolating the lignin may be used in some embodiments, or other amounts of the reactants (i.e., H₂O₂ and NaOH) may be used in some embodiments.

In some embodiments, the dosage of LigWRA in the final mixture may be varied. The experimental program focused on characterizing the effects of increasing dosages of ComWRA and LigWRA on the fresh properties of cement-based systems as shown in Table 1. All the tested mixtures had a constant water-to-cement ratio (w/c), and voids in mineral aggregate (VMA) content, however, these could be varied in other embodiments between approximately 0.25 and 0.75. In some embodiments, the LigWRA may be combined with a liquid such as water. For the assessment of printability, the sand-to-cement ratio (s/c) was kept constant, but this could be varied in other embodiments between approximately 0.25 and 1.5. In some embodiments, the LigWRA may be combined with a binder (or binders) such as sand, gravel, fly ash, furnace slag, woodchips, straw, and/or other material. For rheology and heat of hydration tests, cement paste specimens were prepared separately.

TABLE 1
Experimental program for the assessment
of water-reducing admixtures.

| | | | | WRA | VMA |
|---|---|---|---|---|---|
| Mixture ID | w/c | s/c | WRA Type | wt. % | wt. % |
| Control | 0.35 | 0.75 | — | — | 0.05 |
| 2* | 0.38 | 0.75 | — | — | 0.05 |
| 3* | 0.40 | 0.75 | — | — | 0.05 |
| ComWRA 0.2% | 0.35 | 0.75 | ComWRA | 0.2 | 0.05 |
| ComWRA 0.5% | 0.35 | 0.75 | ComWRA | 0.5 | 0.05 |
| ComWRA 0.8% | 0.35 | 0.75 | ComWRA | 0.8 | 0.05 |
| LigWRA 0.2% | 0.35 | 0.75 | LigWRA | 0.2 | 0.05 |
| LigWRA 0.5% | 0.35 | 0.75 | LigWRA | 0.5 | 0.05 |
| LigWRA 0.8% | 0.35 | 0.75 | LigWRA | 0.8 | 0.05 |

*Mixtures used only for rheological characterization.

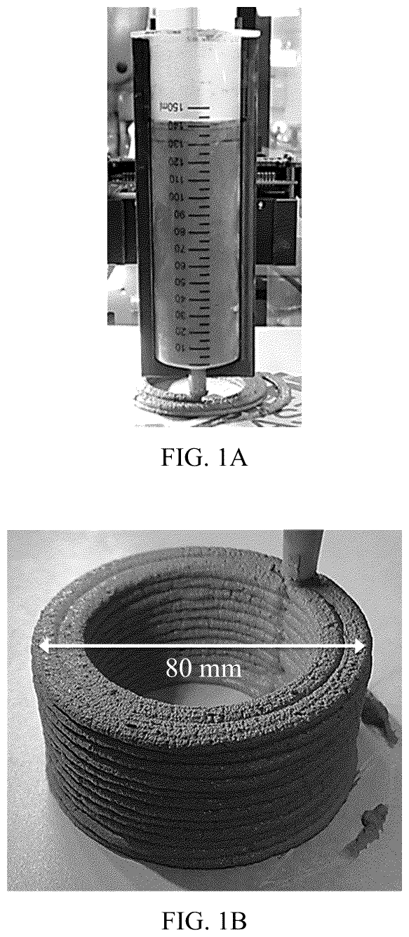

The 3D-printed elements were produced in a Hyrel 30M printer (22.5×20×20 cm³ building size) equipped with a 150 cm³ syringe with a 6-mm nozzle opening and a printing speed of about 600 mm/min (FIG. 1A). The filament was designed with a about 3-mm height and about 6-mm width. Printability and buildability of the mixtures were assessed by producing single-wall and double-wall cylindrical specimens with about 80 mm in diameter (FIG. 1B). The rheological characterization was performed on a Bohlin Gemini HR Malvern Nano Rheometer with a parallel plate configuration (about 40-mm diameter and about 1-mm gap) set at about 25° C. Cement paste specimens were mixed for about 5-minutes and placed on the bottom plate, followed by the application of the about 1-mm gap and removal of excess material. Finally, the effects of the use of the ComWRA and LigWRA on the evolution of heat of hydration were assessed using an 8-channel isothermal calorimeter (TAM Air, TA Instruments) to determine the hydration kinetics of cement pastes after about 100 hours, and the thermal indicator of setting time of the cement paste according to ASTM C1679-19.

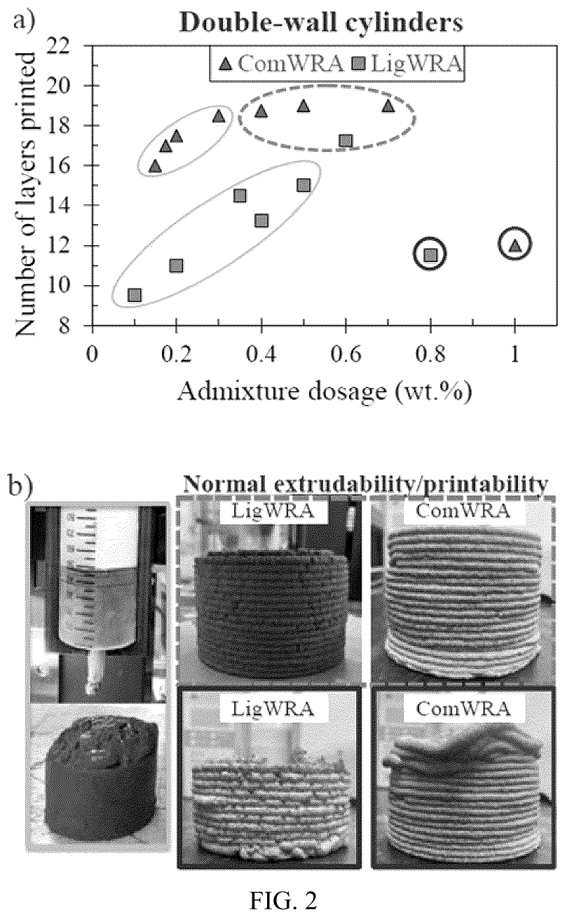

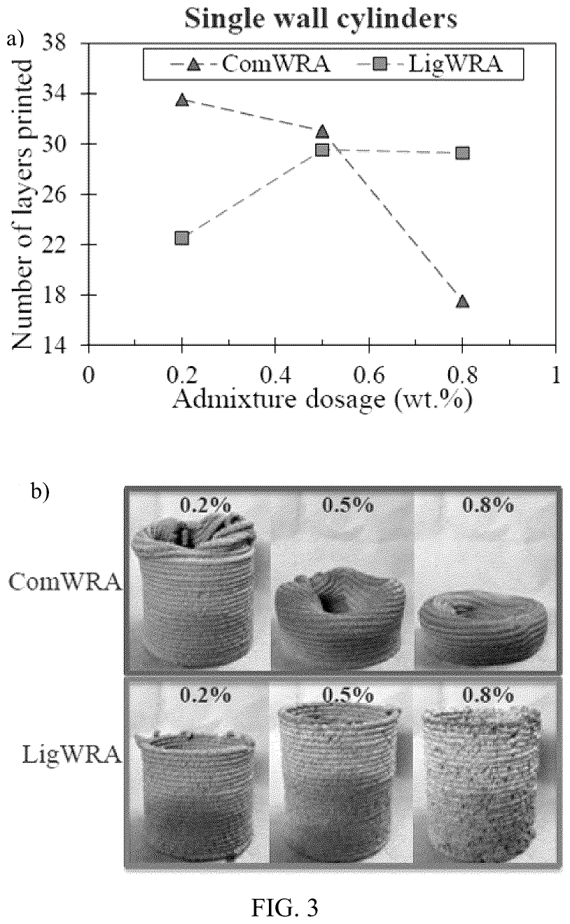

An initial calibration of the mixture development was performed to identify the appropriate s/c and particle size that could satisfy the extrudability of mortars through an approximately 6-mm nozzle (i.e., that could be additively manufactured through an approximately 6 mm nozzle). An iterative process indicated that a s/c of about 0.75 and max particle size of about 0.6 mm were appropriate for further printing experiments along with a combination of VMA and the respective water reducing admixture (i.e., ComWRA or LigWRA) studied. While Table 1 shows the mixtures assessed during the experiments, additional dosages were explored during the 3D-printing process to identify the changes in printability in more detail. FIG. 2 panels a)-b) illustrates the printability performance of double wall cylinders to assess the extrudability (i.e., additive manufacturing potential) of the mixtures using a syringe system, and single-wall cylinders (FIG. 2 panels c)-d)) used to evaluate the stability of thin-wall elements as a function of increasing WRA dosages in the mixtures. Firstly, the effect of the ComWRA and LigWRA was evaluated by increasing their dosages in the range of about 0.15 wt. % to about 1.0 wt. % and about 0.1 wt. % to about 0.8 wt. %, respectively. It was observed that at lower dosages the mixtures exhibited bleeding, as evidenced by slightly more fluid, unstable initial layers and drier, stiffer layers towards the end of the printing, this phase separation of the mixture caused the creation of a “dead zone” in the syringe followed by the obstruction of the plunger (see FIG. 2 panel b) and FIG. 3 panel b)). In the case of ComWRA, this phenomenon was observed with dosages up to about 0.3 wt. %, while for LigWRA, this behavior was observed up to a dosage of about 0.5 wt. %. Increasing dosages gradually reduced the magnitude of the “dead zone” left in the syringe, allowing for a higher number of layers to be printed as the material gained fluidity. In the case of ComWRA, dosages in the range of approximately 0.4 wt. % to approximately 0.7 wt. %, allowed for a complete extrusion of the material and reached the highest number of layers, however, even at approximately 0.7 wt. % a high fluidity in the layers was observed causing instability and buckling. In the case of LigWRA, positive extrudability results were found at a dosage of approximately 0.6 wt. %, after which an adverse reaction of the lignin was observed on the characteristics of the filament. Causing a breakdown of the filaments during printing and a stark decrease in cohesion between layers.

Additionally, single-wall cylinders were printed to assess the buildability of selected dosages of material. In this case, for ComWRA a dosage of about 0.2 wt. % allowed the printing of about 34 layers before failure, further increase in dosage caused a decrease in the stability of the hollow cylinders resulting in buckling after about 31 and about 17 printed layers (about 0.5 wt. % and about 0.8 wt. %, respectively). In the case of LigWRA, a lower dosage (approximately 0.2 wt. %) was able to print approximately 23 layers before failure due to the formation of a “dead zone”. Further increase in LigWRA dosage improved the printability by reaching approximately 29 and approximately 28 layers (approximately 0.5 wt. % and approximately 0.8 wt. %, respectively), with an appropriate filament quality, however at a dosage of approximately 0.8 wt. %, the quality of the filaments showed a poor quality and discontinuities throughout the printing process.

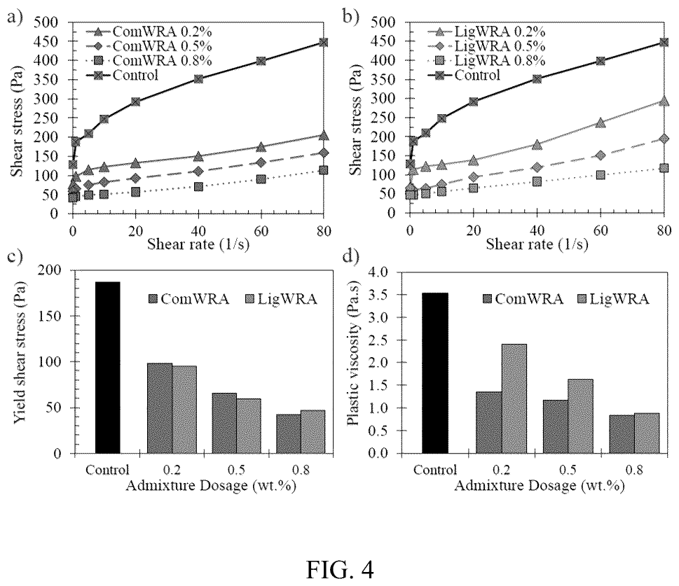

FIG. 4 shows the results of the flow curve obtained for the selected mixtures assessed in a parallel plate setup. The results of ComWRA and LigWRA at different dosages are shown in comparison with the plain OPC paste at the same w/c to illustrate the effectiveness of different dosages. The behavior of the pastes was characterized by obtaining the best fitting Bingham model, thus obtaining the yield stress and plastic viscosity of the mixtures. (See FIG. 4 panel a) for yield stress for ComWRA and FIG. 4 panel b) for yield stress for LigWRA.) FIG. 4 panel c) shows a comparable effect of LigWRA with respect to ComWRA in reducing the yield stress of pastes at different dosages. However, by comparing the effect on plastic viscosity (FIG. 4 panel d)), it was observed that ComWRA has a more significant impact on the estimated viscosity with respect to LigWRA at different dosages.

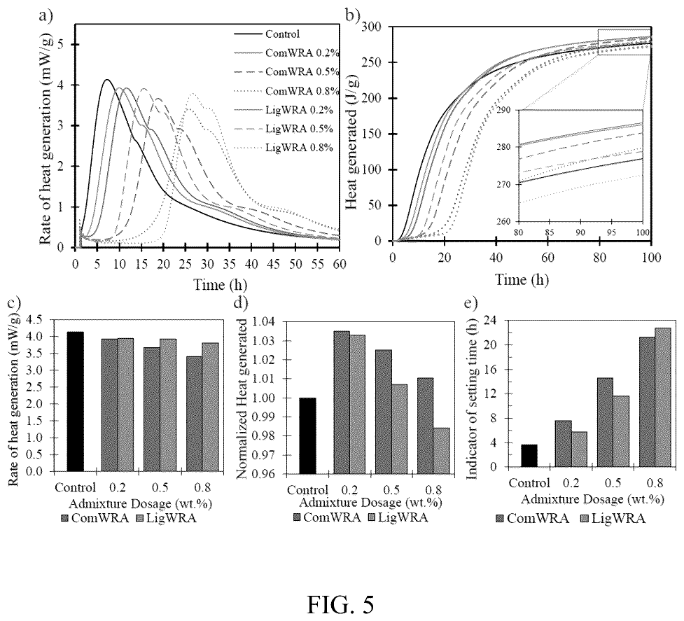

The results of isothermal calorimetry tests, including rate of heat generation, cumulative heat, and indicator of setting time for ComWRA and LigWRA specimens are shown in FIG. 5 panels a)-e). It is possible to observe the substantial effect of increasing dosages of both ComWRA and LigWRA on the thermal power curve, producing a substantial delay in the onset of the acceleration period of hydration compared to the control (i.e., plain OPC) (see FIG. 5 panels a) and b)). Still, the cumulative heat generated after about 100 hours shows a similar performance with respect to the control specimen (plain OPC). Additionally, when comparing the performance of the ComWRA and LigWRA admixtures at same dosages, it is observed that at about 0.2 wt. % dosage, the peak of heat of hydration is substantially identical (i.e., approximately slightly less than 4 mW/g), while for higher dosages, the use of LigWRA has a lower impact in the peak rate of heat as compared to the ComWRA (i.e., the additional LigWRA does not reduce the rate of heat generation significantly) (see FIG. 5 panel c)). Regarding the total heat of hydration generated after 100 hours, it is observed that all the specimens, except for approximately 0.8 wt. % LigWRA, have a slightly higher cumulative heat of hydration (i.e., approximately 275 J/g) when compared to the control case (plain OPC) (FIG. 5 panel b)). Finally, the estimated indicator of setting time shows that specimens with approximately 0.2 wt. % and approximately 0.5 wt. % LigWRA have a significantly shorter setting time when compared to the ComWRA counterparts (approximately 6 hrs for a 0.2 wt. % LigWRA and approximately 11 hours for 0.5 wt. % LigWRA). However, at approximately 0.8 wt. % dosage, the LigWRA specimens have a longer setting time than the ComWRA specimen (approximately 22 hrs for 0.8 wt. % LigWRA compared to approximately 21 hrs for 0.8 wt. % ComWRA) (FIG. 5 panel e)).

The preliminary results from tests performed on the proposed lignin-based admixture show its potential for use in cement-based systems and 3D-printing applications and a comparative performance with respect to a commercial water reducing admixture at the same dosages. While the extrudability/printability experiments indicate the need for higher dosages of LigWRA to overcome the creation of a “dead zone” in the syringe, it was also observed that the chemical modification of the lignin-based admixture successfully influenced the workability of cement pastes and mortar to behave akin to the ComWRA. It is hypothesized that the increase in anionic functionality of the bulky lignin molecule served to both increase electrostatic binding with cement particles and sterically hinder agglomeration of cement particles similar to the effect from PCEs. These benefits facilitate the extrusion process by significantly modifying cement flowability characteristics, which is supported by rheology experiments. From the flow curve results, it is possible to observe that like the ComWRA, LigWRA has a similar effect on decreasing the yield stress of cement pastes for the different dosages evaluated. However, a different behavior was observed in terms of the decrease in the plastic viscosity with respect to the control sample. At dosages of approximately 0.2 wt. % and approximately 0.5 wt. % the LigWRA shows a limited effect on reducing the viscosity than ComWRA. This means a reduction of approximately 32% with LigWRA vs. approximately 62% with ComWRA at approximately 0.2 wt. % dosage, and approximately 54% with LigWRA vs. approximately 67% with ComWRA at approximately 0.5 wt. % dosage, although an approximately 0.8 wt. % dosage causes a similar decrease in viscosity of LigWRA as compared to ComWRA, approximately 75% vs. approximately 76%, respectively. These results support the issues observed during the extrusion. ComWRA produces a drastic decrease in viscosity of the mixtures at lower dosages, which allows for a lower pressure being applied on the material, thus avoiding excessive bleeding and dead zone formation in the extruder. On the other hand, the limited effect on viscosity of LigWRA at lower dosages can be related to the resistance of the mixture to be deformed by the displacement of the plunger and effectively directed to the nozzle opening, therefore, causing an increase in pressure of the bulk mixture, bleeding, and excessive torque required from the motor. Additionally, tests performed on mixtures with different w/c ratios indicate similar trends with respect to appropriate dosage and a lower impact of LigWRA materials on the delay of setting time when compared to ComWRA (i.e., LigWRA maintains shorter setting times at concentrations of 0.2 wt. % and 0.5 wt. % compared to ComWRA. Finally, from the perspective of the effects of LigWRA on setting time, the main objective is to satisfy the requirements for admixtures given by ASTM C494, thus based on the current results, lower dosages around 0.2 wt. % of LigWRA are permitted to be considered as a water reducing set retarder admixture. However, other dosages may be utilized as an admixture, not aligned with ASTM C494 standards.

The present disclosure describes a water-reducing admixture (LigWRA) derived from an industrial byproduct for applications in cement-based systems. LigWRA may modify the fresh-state characteristics of cement-based systems, thus influencing the printability of mortar mixtures. LigWRA may have a significant impact on the yield stress, at the same level as a ComWRA used for comparison, however its low impact on the viscosity could have influenced the extrudability at lower dosages, affecting the extrudability of mixtures with the syringe system used.

The foregoing discussion and examples have been presented for purposes of illustration and description. The foregoing is not intended to limit the aspects, embodiments, or configurations to the form or forms disclosed herein. In the foregoing Detailed Description for example, various features of the aspects, embodiments, or configurations are grouped together in one or more embodiments, configurations, or aspects for the purpose of streamlining the disclosure. The features of the aspects, embodiments, or configurations may be combined in alternate aspects, embodiments, or configurations other than those discussed above. This method of disclosure is not to be interpreted as reflecting an intention that the aspects, embodiments, or configurations require more features than are expressly recited in each claim. Rather, as the following claims reflect, inventive aspects lie in less than all features of a single foregoing disclosed embodiment, configuration, or aspect. While certain aspects of conventional technology have been discussed to facilitate disclosure of some embodiments of the present invention, the Applicants in no way disclaim these technical aspects, and it is contemplated that the claimed invention may encompass one or more of the conventional technical aspects discussed herein. Thus, the following claims are hereby incorporated into this Detailed Description, with each claim standing on its own as a separate aspect, embodiment, or configuration.

What is claimed is:

1. A method comprising:
preparing a lignin-based water-reducing admixture (LigWRA);
combining the LigWRA with a binder and a liquid to form a cement; and
extruding the cement to form a concrete.

2. The method of claim 1, wherein:
the binder comprises at least one of sand or gravel.

3. The method of claim 1, wherein:
the binder and LigWRA are combined in a ratio of approximately 0.75.

4. The method of claim 1, wherein:
the liquid comprises water.

5. The method of claim 1, wherein:
the liquid and the LigWRA are combined in a ratio of approximately 0.35.

6. The method of claim 1, wherein:
the extruding comprises:
directing the cement through a nozzle to form a shape; and
allowing the shape to set to form the concrete.

7. The method of claim 6, wherein:
the allowing is performed for approximately less than twenty four (24) hours.

8. The method of claim 1, wherein:
the cement is in the range of approximately 0.2 wt. % to approximately 0.8 wt. % LigWRA.

9. The method of claim 1, wherein the preparing comprises:
isolating a lignin in a black liquor;
oxidizing the lignin;
dialyzing the lignin; and
lyophilizing the lignin, resulting in a lignin-based water-reducing admixture (LigWRA).

10. The method of claim 9, wherein:
the isolating comprises:
utilizing a sulfuric acid to precipitate the lignin within the black liquor;
centrifuging the lignin;
water washing the lignin; and
drying the lignin.

11. The method of claim 9, wherein:
the oxidizing comprises:
mixing the lignin with a source of O₂.

12. The method of claim 11, wherein:
the source of O₂ comprises at least one of hydrogen peroxide or ozone.

13. The method of claim 9, wherein:
the dialyzing was performed in the range of approximately 0.5 kDa to approximately 1 kDA for at least eight (8) hours.

14. The method of claim 9, wherein:
the dialyzing results in a particle being removed from the lignin.

15. The method of claim 9, further comprising:
dissolving the LigWRA in water.

16. A composition comprising:
a lignin-based water-reducing admixture (LigWRA);
a binder; and
a liquid; wherein:
the LigWRA comprises an isolated lignin from a black liquor byproduct of sustainable aviation fuel.

17. The composition of claim 16, wherein:
the composition is in the range of approximately 0.2 wt. % to approximately 0.8 wt. % LigWRA.

18. The composition of claim 16, wherein:
the binder comprises at least one of sand or gravel.

19. The composition of claim 16, wherein:
the liquid comprises water.

20. The composition of claim 16, wherein:
the composition has a rate of heat generation of approximately 4.0 mW/g.
